(19) United States
(12) Patent Application Publication
(10) Pub. No.: US 2006/0052920 A1
(43) Pub. Date: Mar. 9, 2006

(54) Tire condition detecting system and method

(75) Inventor: Nobuya Watabe, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/208,598

(22) Filed: Aug. 23, 2005

(30) Foreign Application Priority Data
Sep. 3, 2004 (JP) 2004-256691

(51) Int. Cl. G06F 19/00

(52) U.S. Cl. 701/29; 340/442

(57) ABSTRACT

A tire condition detecting system with a batteryless transmitter determines intervals among transmission timings of an electrical wave for electrical charging to the transmitter, according to a change between tire condition stored at the last transmission timing and the present transmission timing. Specifically, the system sets an interval between the present transmission timing and the next transmission timing to be a predetermined maximum interval if the calculated change is smaller than a first threshold, sets the interval to be a predetermined minimum interval if the change is larger than a second threshold larger than the first threshold, and sets the interval to be an intermediate interval if the change is larger than the first threshold and smaller than the second threshold.

### CROSS REFERENCE TO RELATED APPLICATION

This application is based on and incorporates herein by reference Japanese patent application No. 2004-256691 filed on Sep. 3, 2004.

### FIELD OF THE INVENTION

The present invention relates to a tire condition detecting system and method using a transmitter and a receiver to detect air pressure of a tire, wherein the transmitter is installed in a wheel having the tire. The transmitter includes a sensing unit and transmits a detection signal which the sensing unit outputs. The receiver is installed in a chassis of a vehicle and receives the detection signal from the transmitter.

### BACKGROUND OF THE INVEHTION

In conventional tire air pressure detecting systems, a tire air pressure detecting system has a transmitter, which is installed in a wheel having a tire and has a sensing unit such as a pressure sensor. The system also has a receiver which has an antenna and is installed in a chassis of a vehicle. When the transmitter transmits a radio wave including a detection signal received from the sensing unit, the receiver receives the wave by means of the antenna. Thus, air pressure of the tire is monitored at the chassis side.

The transmitter transmits waves including the detection signals at intervals to prolong a battery life of the transmitter in the wheel. Thus, the detecting system is designed to reduce electric power consumption. Moreover, the detecting system is designed to shorten the intervals than usual when an anomalous event occurs. The anomalous event may be an excessive pressure reduction, rapid decompression, and an excessive temperature increase. Additionally, the system prolongs the intervals to reduce the consumption of the battery when the vehicle is not moving, and shortens the intervals when it is moving.

Thus, the system reduces the power consumption by changing the detection signal transmission intervals depending on the situation (JP3428466).

Although the tire system shortens the intervals than usual in an anomalous event, it possibly fails to sense the anomalous event, for example tire burst, whose duration is shorter than the usual intervals. If the system is designed to transmit the detection signal at shorter intervals than the usual intervals regularly in order to sense such an urgent anomalous event, it will consume power of its battery heavily and the life of the battery would be significantly reduced.

In JP H08-172675A a batteryless transmitter is proposed which receives power supply via radio waves for electrical charging (hereafter charging waves) and requires no battery in it.

Because the batteryless transmitter is free from battery exhaustion, it can obtain pressure at shortest intervals regularly and sense urgent anomalous events.

However, when the transmitter is receiving electrical power by means of the charging wave from the chassis-side, the charging wave possibly jam wireless communications in neighboring vehicle. From another aspect, a radio wave including a detection signal from the transmitter is possibly jammed by a charging wave from another vehicle and the ratio of the reception of the detection signals possibly degrades.

### SUMMARY OF THE INVENTION

The present invention addresses the above point. Thus, it is an objective of the present invention to improve a tire condition detecting system and a method using a batteryless transmitter.

A tire condition detecting system and method of the present invention has a transmitter and a receiver. The transmitter is installed in a wheel of the vehicle and the receiver is installed in a chassis of the vehicle. The receiver has a memory and stores the condition of the tire in the memory according to a detection signal from the transmitter. Then, the receiver determines an interval among transmission timings of transmitting a charging wave to the transmitter, according to a change in the condition stored earlier.

Thus, the interval among the transmission timings and hence a next transmission timing is changed depending on the change in the conditions. Therefore, the tire condition detecting system can shorten the interval of the transmission timings of the detection signal regarding the wheel which is in an urgent situation where it is necessary to obtain its tire condition at a short interval.

### BRIEF DESCRIPTION OF THE DRAWINGS

The invention, together with additional objective, features and advantages thereof, will be best understood from the following description, the appended claims and the accompanying drawings in which:

FIG. 1 shows a block diagram of a tire air pressure detecting system in the embodiment of the present invention;

FIG. 2A shows a block diagram of a transmitter in the embodiment;

FIG. 2B shows a block diagram of a receiver in the embodiment;

FIG. 3 shows a flowchart of the transmission timing determination processes in the embodiment; and

FIG. 4 shows a timing chart of operations of the transmitter in the embodiment.

### DETAILED DESCRIPTION OF THE INVENTION

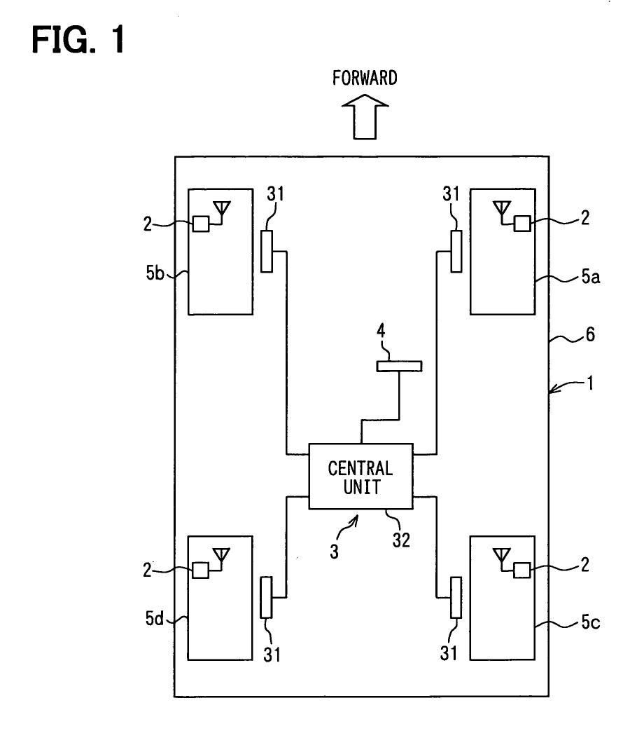

As shown in FIG. 1, a tire air pressure detecting system is installed in a vehicle 1 as a tire condition detecting system. The system has transmitters 2, a receiver 3 and a warning unit 4.

The transmitters 2 are installed in wheels 5a-5d of the vehicle 1. Each transmitter 2 is attached to an air injection valve in a wheel disk of the corresponding wheel 5a-5d. The transmitter 2 detects pneumatic air pressure of a tire of the corresponding wheel 5a-5d, puts together detected pressure into a response frame, and transmits the response frame. The receiver 3 is installed in a chassis 6 of the vehicle 1 and transmits an electrical wave for electrical charging (hereafter charging wave) to the transmitters 2. Moreover, the receiver 3 receives the response frames from the transmitters 2 and executes various processes and calculations using the detected pressure in the response frames to monitor air pressure of the tires.

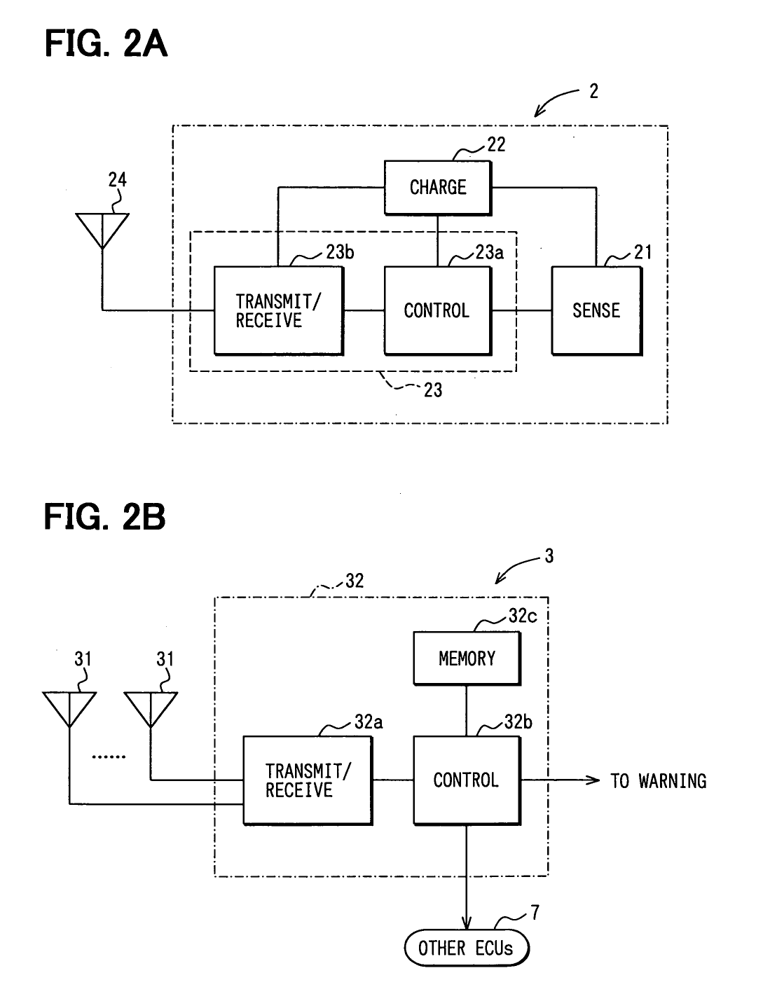

Each transmitter 2 charges by means of the charging wave from the receiver 3 and is driven by the charged power. Specifically, as shown in FIG. 2A each transmitter 2 has a sensing unit 21, a charging unit 22, a central unit 23, and an antenna 24. The transmitter 2 operates on receiving the charging wave through the antenna 24, by converting the wave into electrical power and storing the electrical power into the charging unit 22. This transponder method in electrical charging is widely known.

The charging unit 22 stores electrical power in the charging wave received through the antenna 24 and supplies the electrical power to the sensing unit 21 and the central unit 23 every time on receiving the charging wave.

The sensing unit 21 is exposed to the inner space of the corresponding tire. The sensing unit 21 includes for example a diaphragm type pressure sensor and outputs a detection signal indicating the tire air pressure every time it receives the electrical power from the charging unit 22.

The central unit 23 has a controller 23a and a wireless-wave unit 23b. The controller 23a has a CPU, a ROM, a RAM and an input/output. The CPU executes predetermined processes according to a program stored in the ROM every time it receives the electrical power from the charging unit 22.

Specifically, every time the controller 23a receives the detection signal from the sensing unit 21, the controller 23a processes the signal and put the resultant pressure and a wheel ID in the response frame. The wheel ID is an identifier to distinguish each wheel from other wheels. Then the controller 23a transmits the response frame as a processed detection signal to the receiver 3 through the wireless-wave unit 23b.

The processes for transmitting the frame to the receiver 3 is executed according to the program, when the transmission of the charging wave stops or when the charging unit 22 stores sufficient power to transmit the response frame. For example, the controller 23a monitors the charging wave from the receiver 3 and executes the process for transmitting the frame on sensing a down edge profile of the monitored signal, which appears when the transmission of the charging wave stops. The down edge is a notification from the receiver to the transmitter of the timing of the transmission.

The wireless-wave unit 23b not only receives the charging wave and outputs them to the charging unit 22 and the controller 23a, but also transmits the response frame received from the controller 23a to the receiver 3.

Thus, the transmitters 2 detect the air pressure of the corresponding tires and transmit the response frames through the corresponding antennas 24 recursively.

The receiver 3 adjusts timings of charging and makes the transmitters 2 charge at the timings, so that the transmitters 2 transmit the response frame at certain timings. In addition, the receiver 3 monitors air pressure of the tires based on response frames transmitted by the transmitters at the timings.

The number of the antennas 31 is the same as the number of the tires, that is, the number of the transmitters 2. Each antenna 31 is located at a position related to one of the transmitters 2 in one-to-one correspondence. For example, each antenna 31 is fixed at a predetermined distance to the corresponding transmitter 2. The antenna 31 is duplex antennas, which transmits the charging wave, receives the response frames. However, the antenna 31 may have an antenna dedicated for transmitting and an antenna dedicated for receiving, separately.

As shown in FIG. 2, the central unit 32 has a wireless-wave unit 32a, a controller 32b, and a memory 32c having a non-volatile EEPROM. The controller 32b has a CPU, a ROM, a RAM, an input/output, and a counter. The CPU executes predetermined processes in accordance with a program stored in the ROM.

The wireless-wave unit 32a outputs through the antenna 31 the charging wave under control of the controller 32b, and receives the response frames from the transmitters 2 and sends the frames to the controller 32b.

The controller 32b determines timings of transmission of the response frame by the transmitter 2 based on transmission timing determination processes described below, and transmits the charging wave so that each charging unit 22 completes collecting electric power at the timings of the transmission of the response frame. If the transmitter 2 is designed to transmit the frame triggered by the end of the transmission of the charging wave, the controller 32b stops the transmission of the charging wave in time with the timing of transmission of the frame. In addition, the controller 32b receives the response frame from the wireless-wave unit 32a and specifies a wheel in which a corresponding transmitter 2 transmitted the received frame among the wheels 5a-5d according to an wheel ID stored in the frame.

In addition, the controller 32b executes various signal processing and calculations according to the detected pressure in the received frame to monitor the tire air pressure of the wheels 5a-5d and to output an electric signal depending on the obtained pressure to the warning unit 4, thereby to indicate abnormality in tire pressure.

Specifically, the controller 32b makes a decision as to whether the tire air pressure is below a predetermined threshold. Based on the decision of YES (low pressure), it outputs a signal indicating the reduction of the tire air pressure to the warning unit 4.

Moreover, the controller 32b sends various tire air pressure to other ECUs 7 which execute other vehicle controls through an in-vehicle LAN such as a CAN. The ECUs 7 may include a brake ECU, an engine ECU and the like and act as vehicle controllers. In addition, the controller 32b may receive a signal requesting for tire air pressure from the ECUs 7 and return the pressure to the ECUs 7 based on the reception. Therefore, the ECUs 7 can execute vehicle control such as brake control and engine control based on the pressure received from the controller 32b. Thus, a vehicle control device is constructed by the tire air pressure detecting system, the ECUs 7, actuators driven by the ECUs 7 and so on. The actuators which are not illustrated may be a brake device or an engine control mechanism. Then the vehicle control device executes the bake control and the engine control depending on the tire air pressure detected by the tire air pressure detecting system.

The memory 32c stores various results of the calculations of the controller 32b and the detected tire air pressure, by relating each of them to one of the wheels 5a-5d.

The warning unit 4 is located at a position where a driver can look at it and has at least one of a warning lamp, a warning display, and a warning buzzer, each of which is located in the instrument panel of the vehicle 1. When the warning unit 4 receives a signal indicating reduction of the tire air pressure from the controller 32b of the receiver 3, it gives a warning message accordingly to notify the driver of the reduction.

Next, the operation of the tire air pressure detecting system constructed as above will be described.

First, the receiver 3 transmits the charging wave to each transmitter 2 through the corresponding antenna 31 just before the timing of the transmission of the response frame by the transmitter 2. The timing of the transmission of the charging wave (hereafter charge timing) is determined by executing transmission timing setting processes described later.

The corresponding transmitter 2 receives the charging wave and the charging unit 22 stores the electrical power. When the charging unit 22 stores sufficient electrical power, the central unit 23 puts a result of pressure detection by the sensing unit 21 into the response frame and transmits the resultant frame to the receiver 3. The charging unit 22 may be regarded to have stored sufficient electrical power when voltage of its capacitor reaches a predetermined charging voltage.

When the receiver 3 receives the response frame from the transmitter 2, the controller 32b specifies one of the transmitters 2 which transmitted the received frame by means of the ID therein according to the result of the detection in the received frame. Then the controller 32b stores the calculated pressure into the memory 32c. Moreover, the controller 32b makes a decision as to whether the calculated pressure is below the predetermined threshold, and based on the decision of YES, outputs the signal indicating the excessive decrease in pressure to the warning unit 4.

Moreover, the controller 32b sends tire air pressure to the ECUs 7 every time it obtains the pressure or every time it receives a signal requesting for the pressure from the ECUs 7. Thus, the ECUs 7 becomes capable to execute most appropriate brake control or engine control according to the tire air pressure.

Next, the transmission timing determination processes will be described in detail. The controller 32b executes the processes just after each timing of transmission of the response frame by one of the transmitters 2 (hereafter frame transmission timing), based on the tire air pressure at the preceding frame transmission timing.

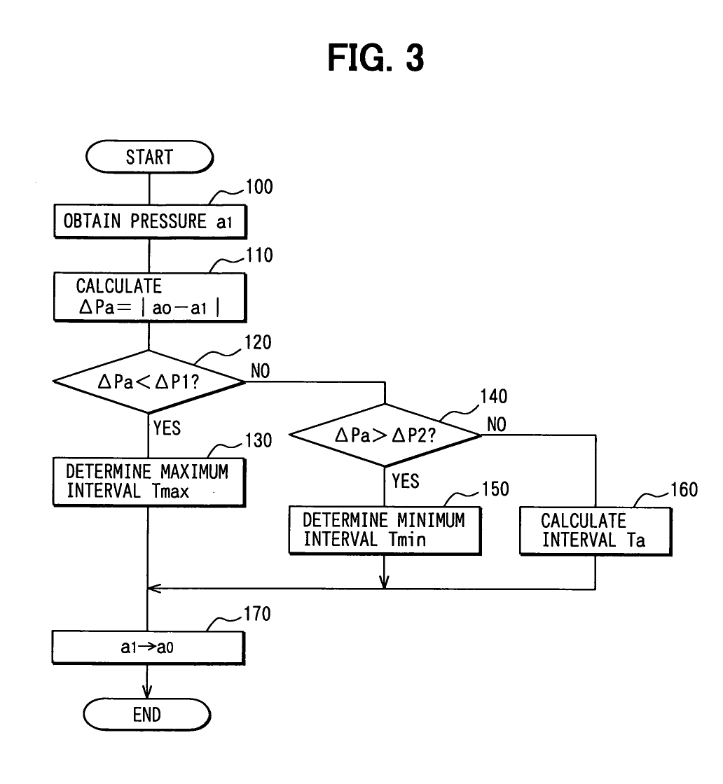

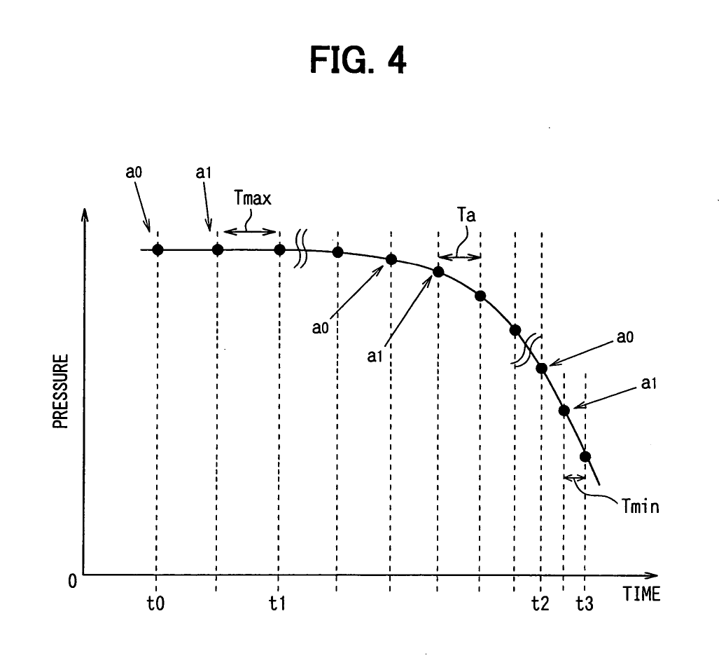

The method of determining the frame transmission timing will be described with reference to FIG. 3 and FIG. 4. In FIG. 4, transmission timings of the response frame are shown with dots.

At step 100, the controller 32b obtains present tire air pressure a1. The present tire air pressure is the tire air pressure the controller 32b obtained most recently.

Subsequently at step 110, the controller 32b calculates absolute value of the difference ΔPa between the previous tire air pressure a0 and the present tire air pressure a1 (namely, ΔPa=|a1−a0|). The previous tire air pressure a0 is the tire air pressure which the controller 32b obtained at the previous frame transmission timing, that is, just before the timing of the previous execution of the timing determination processes.

Subsequently at step 120, the controller 32b makes a decision as to whether the calculated absolute value ΔPa is smaller than a first threshold ΔP1. The first threshold ΔP1 is a reference value as to whether the difference ΔPa is small enough to conclude that the tire air pressure is hardly changing. Therefore, if the difference ΔPa is smaller than the first threshold ΔP1, the value ΔPa indicates no anomalous or urgent situation.

Therefore, if the decision is YES, the controller 32b determines the following frame transmission timing at step 130 so that the interval between the present transmission timing and the next transmission timing becomes a predetermined maximum interval Tmax (see a period between t0 and t1 in FIG. 4).

If the decision at step 120 is NO, the controller 32b makes a decision as to whether the calculated absolute value ΔPa is larger than a second threshold ΔP2 at step 140. The second threshold ΔP2 is a reference value larger than ΔP1 and set to determine whether the difference ΔPa is large enough to conclude that the tire air pressure is changing drastically and that it is necessary to obtain the tire air pressure of a corresponding wheel at a shorter interval, that is, more frequently. Here, the corresponding wheel is one of the wheels 5a-5d having one of the transmitters 2 which has transmitted the received response frame. Therefore, if the difference ΔPa is larger than the second threshold ΔP2, there is an urgent or anomalous situation.

Therefore, if the decision of the step 140 is YES, the controller 32b determines the next frame transmission timing at step 150 so that the interval between the last frame transmission timing and the next transmission timing becomes a predetermined minimum interval Tmin. The minimum interval may be determined as an interval at which the tire air pressure detecting system executes the transmissions as quickly as possible. On the other hand, the minimum interval may be determined as an interval short enough to respond well to the urgent situation (see a period between t2 and t3 in FIG. 4).

If the decision at step 140 is NO, it can be concluded that the calculated absolute value ΔPa indicates neither that there is not effective change in the tire air pressure nor that the situation is urgent. In this case, the inequation ΔP1<ΔPa<ΔP2 holds. In this case, the controller 32b executes an interval calculation process at step 160 to adjust the interval between the last frame transmission timing and the next transmission timing.

In the interval calculation process of step 160, the interval may be calculated by means of the following equation.
Ta=Tmin+(Tmax−Tmin)×|ΔP2−ΔPa|/|ΔP2−ΔP1|

The equation gives an intermediate interval Ta which depends on the calculated absolute value ΔPa and is between the maximum interval Tmax and the minimum interval Tmin (see a period between t1 and t2 in FIG. 4).

After the determination of the interval, the controller 32b specifies the next frame transmission timing depending on the determined interval. Then the controller 32b transmits charging waves so that the transmitter 2 transmits the next response frame at the specified timing.

Subsequently, the controller 32b stores the present tire air pressure a1 into the memory 32c at step 170 and ends the interval calculation processes.

As described above, the tire air pressure detecting system of the embodiment recursively calculates the next frame transmission timing, based on the previous tire air pressure a0 and the present tire air pressure a1, and then calculated absolute value ΔPa. The next frame transmission timing is calculated for each time.

The tire air pressure detecting system can thus specify at least one of the wheels 5a-5d which is in an urgent situation where it is necessary to obtain its tire air pressure at a short interval and shorten only the interval between the frame transmission timings of such a wheel.

Thus, in a case where the receiver 3 supplies electrical power to the transmitter 2 by charging waves, the receiver 3 does not transmit charging waves beyond necessity. This reduces the possibility that the receiver 3 jams wireless communications in other vehicles. Besides, this will also reduce the possibility that reception of response frames from the transmitter 2 is jammed because of charging waves from another vehicle and that the ratio of the reception decreases.

The receiver 3 may be designed to receive the detection signals of air pressure from the four wheels at different timings. In this case, the interval between frame transmission timings is shortened for only a wheel in an urgent situation. Therefore, it does not take too much time to process detection signals of tire air pressure from the other wheels which are not in urgent situation. Thus, the receiver 3 can process the detection signals from the wheel in an urgent situation and update data regarding the tire air pressure of the wheel without long delay.

As an result, the tire air pressure detecting system can determine suitable intervals among the frame transmission timings.

Moreover, the tire air pressure detecting system obtains data related to the tire air pressure from the wheel in an urgent situation at a short interval. Therefore the controller 32b can send the obtained data to other ECUs 7 at a short interval.

Thus, the ECUs 7 can execute brake control or engine control sensitively to urgent abnormalities, such as influential changes causing a tire burst, which require up-to-date information. For example, in vehicle attitude control such as ABS control and anti side slipping control, the tire air pressure detecting system can execute suitable control by adjusting slipping ratio according to the tire air pressure.

### MODIFICATIONS

The present invention should not be limited to the embodiment discussed above and shown in the figures, but may be implemented in various ways without departing from the spirit of the invention. For example, the frame transmission timings of the wheels 5a-5d can be determined independently. In this case, two frame transmission timings corresponding to different wheels may collide with each other. To avoid this collision, the tire air pressure detecting system may give priority in transmission to the wheel with the lowest tire air pressure. However, it is preferable to give the priority to the wheel with the high absolute value of the change of pressure ΔPa.

Because there are cases in which wheels 5a-5d lose their tire air pressure in an ordinary course of events, a low value of tire air pressure does not always indicate urgency. Therefore, if the tire air pressure detecting system gives the priority to the wheel with the highest absolute value of the difference ΔPa, it becomes capable to execute detection of tire air pressure which is closely related to urgency.

In addition, the interval calculation process of step 160 can be executed by using the equation Ta=T0×ΔP2/ΔPa in replace of the equation in the embodiment, wherein T0 is an interval between the present and the last frame transmission timings. In this case, if the calculated interval is longer than Tmax, the calculated value can be replaced by Tmax. Moreover, if the calculated interval is shorter than Tmin, the calculated value can be replaced with Tmin.

By using the equation, the transmission timing of the next time becomes a timing at which the tire air pressure is estimated to change by the value ΔP2. The estimation is based on linear extrapolation according to the previous tire air pressure a0 and the present tire air pressure a1.

However, the estimation can be based on the extrapolation according to the tire air pressure of the present timing and the last plurality of N timings. In this case, the extrapolation can be of higher order (ex. 2nd order, 3rd order, 10th order) such as Lagrangian interpolation. By using the extrapolation of higher order, the tire air pressure detecting system can detect the tire air pressure at more suitable timings.

In addition, any other condition than tire air pressure may be used in determining the frame transmission timing. For example, the tire air pressure detecting system may specify a change of tire air temperature according to a detection signal from a temperature sensor included in the corresponding sensing unit 21, and determine frame transmission timings so that intervals among the timings becomes shorter as the specified change of the temperature becomes larger. Moreover if the tire air pressure detecting system determines the intervals according to the changes of both the tire air pressure and the tire air temperature, it can possibly determine more suitable frame transmission timings.

In addition, the tire condition detecting system may specify the change of tire vibration frequency according to a detection signal from a vibration sensor included in the corresponding sensing unit 21, and determine frame transmission timings so that intervals among the timings becomes shorter as the specified change of the frequency becomes larger.

Thus, it is sufficient if the tire air pressure detecting system specifies the change in condition of a tire according to a detection signal from a corresponding sensor included in the corresponding sensing unit 21 and determines frame transmission timings so that intervals among the timings becomes shorter as the specified change becomes larger.

In addition, the antennas 31 may be replaced by an antenna commonly used for all the transmitters 2.

In addition, the controller 23a may store tire condition received from the sensing unit 21 and make the wireless-wave unit 23b transmit the change between the tire condition received at the present time and the last time. Then, the controller 32b may receive the change through the wireless-wave unit 32a and determine the interval between the present transmission timing and the next transmission timing according to the change.

The controller 23a may also store tire condition received from the sensing unit 21, calculate change between the tire condition received at the present time and the last time and determine the interval between the present transmission timing and the next transmission timing according to the change, as the controller 32a of the above embodiment does. Then the controller 23a may make the wireless-wave unit 23b transmit the interval and the controller 32b may receive the interval and determine the interval as the interval between the present transmission timing and the next transmission timing according to the change.

What is claimed is:

1. A tire condition detecting system for a vehicle comprising:
a transmitter installed in a vehicle wheel having a tire, the transmitter including:
a sensing unit for recursively outputting a detection signal related to condition of the tire;
a first wireless-wave unit for receiving an electrical wave for electrical charging; and
a charging unit for storing and supplying electrical power of the received electrical wave;
wherein the first wireless-wave unit transmits the detection signal by means of the electrical power supply; and
a receiver installed in a chassis of the vehicle, including:
a memory;
a second wireless-wave unit for receiving the detection signal from the transmitter and transmitting the electrical wave; and
a chassis-side controller for determining the condition of the tire according to the received detection signal, wherein the chassis-side controller is further for:
storing the condition of the tire corresponding to the transmitter into the memory according to the received detection signal;
specifying a change in the condition stored in the memory;
determining according to the specified change an interval between transmission timings at which the second wireless-wave unit transmits the electrical wave to the transmitter; and
making the second wireless-wave unit transmit the electrical wave for electrical charging to the transmitter at the determined interval.

2. The tire condition detecting system according to claim 1, wherein the change which the chassis-side controller calculates is a change between the conditions stored at a last transmission timing and a present transmission timing, and the interval determined by the chassis-side controller becomes at its maximum if the calculated change is smaller than a first threshold.

3. The tire condition detecting system according to claim 2, wherein the interval determined by the chassis-side controller becomes at its minimum if the calculated change is larger than a second threshold which is larger than the first threshold.

4. The tire condition detecting system according to claim 3, wherein the chassis-side controller determines the interval to be an intermediate value between the minimum value and the maximum value, if the calculated change is larger than the first threshold and smaller than the second threshold.

5. The tire condition detecting system according to claim 1, wherein the chassis-side controller estimates a subsequent change in the condition of the tire by means of extrapolation of higher order than a first order according to the stored conditions in past transmission timings and determines the interval between a present transmission timing and a next transmission timing based on the subsequent change.

6. The tire condition detecting system according to claim 1, wherein the chassis-side controller stores conditions related to tire air pressure in the memory, specifies a change in the tire air pressure and determines the interval according to the specified change.

7. The tire condition detecting system according to claim 1, wherein the chassis-side controller stores conditions related to tire air temperature into the memory to the memory, specifies a change in the tire air temperature and determines the interval according to the specified change.

8. The tire condition detecting system according to claim 1, wherein the chassis-side controller stores conditions related to tire vibration frequency into the memory into the memory, specifies a change in the tire vibration frequency and determines the interval according to the specified change.

9. The tire condition detecting system according to claim 1, wherein the chassis-side controller determines the interval so that the interval becomes longer if the specified change becomes larger.

10. The tire condition detecting system according to claim 1, further comprising a control unit which receives the conditions of the tire from the receiver and executes at least either of brake control and engine control according to the conditions.

11. The tire condition detecting system according to claim 1, wherein:
the chassis-side controller is further for making the second wireless-wave unit notify the transmitter of a timing of the transmission by the wireless-wave unit which depends on the determined interval; and
the wireless-wave unit transmits the detection signal at the notified timing.

12. A method for detecting tire condition of a vehicle, the method comprising steps of:
transmitting an electrical wave for electrical charging recursively to a wheel-side device installed in a wheel of the vehicle from a chassis-side device installed in a chassis of the vehicle;
detecting condition of a tire of the wheel recursively by the wheel-side device;
transmitting a signal related to the detected condition from the wheel-side device to the chassis-side device by means of electrical power transmitted in the electrical wave; and
determining a next timing of the step of transmitting an electrical wave according to the signal related to the detected condition.

13. The method according to claim 12, wherein:
the detected condition is a change in a predetermined parameter in the tire; and
the next timing is delayed more as the change is smaller.
